(19) United States
(12) Patent Application Publication
(10) Pub. No.: US 2005/0284779 A1
(43) Pub. Date: Dec. 29, 2005

(54) CD and DVD Index Sheet

(75) Inventor: David C. Cooper, San Diego, CA (US)

Correspondence Address: DAVID C. COOPER, 6540 REFLECTION DRIVE, #1426, SAN DIEGO, CA, 92124, US

(73) Assignee: David C. Cooper, San Diego, CA (US)

(21) Appl. No.: 11/163,020

(22) Filed: Oct. 3, 2005

Related U.S. Application Data
(60) Provisional application No. 60/593,457, filed on Jan. 16, 2005.

(51) Int. Cl. B65D 85/30; G09F 3/00; B42D 15/00

(52) U.S. Cl. 206/308.1; 40/340; 283/67

(57) ABSTRACT

A CD and DVD index sheet includes a tabbed single- or multi-page sheet placed on or between CD or DVD discs stored on a spool. The index sheet tab extends beyond the circumference of the discs and may be written or printed on to provide easy identification of an individual disc on the spool. The remainder of the index sheet may be printed or written on to provide additional information.

### CROSS-REFERENCE TO RELATED APPLICATION(S)

This application claims priority to U.S. Provisional Application No. 60/593,457, filed Jan. 16, 2005, entitled “CD and DVD Index Sheet” which is hereby incorporated by reference in its entirety.

### BACKGROUND

The recent proliferation of digital information (data files, pictures, music, movies, etc.) has resulted in an increasing demand for storage on CD and DVD discs.

Many consumers purchase blank CD or DVD media on spools of 10 discs or more, but these spools provide no easy way to identify a single disc. Therefore, consumers purchase other devices to store their discs in a way which provides easy identification, such as traditional jewel cases, slim-line cases, disc storage booklets with multiple vinyl pages, etc.

However, none of these storage devices are as space-saving and cost-effective as keeping the discs on the original spool, provided there is an easy way to identify individual discs.

### BRIEF SUMMARY

It is therefore the primary object of this invention to provide a disc storage system and a method of assembly utilizing tabbed index sheets to allow easy identification and selection of individual CD or DVD discs stored on a spool.

It is another object of this invention to provide tabbed index sheets of one or more pages in various shapes.

It is another object of this invention to provide a method of printing or writing information on the index sheet tab which aids in the identification of individual discs.

Still another object of this invention is to provide a method of printing or writing supplemental information of various forms upon one or both sides of the index sheet pages, such as a table of CD or DVD disc contents, thumbnail pictures of images or video chapters, album art, liner notes, and so forth.

### DESCRIPTION OF THE DRAWINGS

FIG. 1 is an illustration of one embodiment of a disc storage system, including a top view of an index sheet, a top view of a CD or DVD disc, and an illustration of a spool and removable cover.

FIG. 2 is an illustration of one embodiment of a method for assembling a disc storage system.

FIG. 3 is a top view of sample embodiments of index sheets of various shapes.

FIG. 4 is a top view of sample embodiments of index sheets of various shapes having one or more tabs.

FIG. 5 is a top view of sample embodiments of index sheets of various shapes having one or more pages.

FIG. 6 is an illustration of one embodiment of a method for assembling the disc storage system using index sheets having more than one page and folded into booklet form.

FIG. 7 is an illustration of one embodiment of a method for printing information on the tab or tabs of an index sheet.

FIG. 8 is a top view of one embodiment of printing information on an index sheet.

FIG. 9 is a top view of one embodiment of printing information and an array of thumbnail images on an index sheet.

FIG. 10 is a top view of one embodiment of printing an array of thumbnail images on an index sheet.

FIG. 11 is an illustration of one embodiment of printing information including graphics or images on both sides of an index sheet having multiple pages.

### DETAILED DESCRIPTION

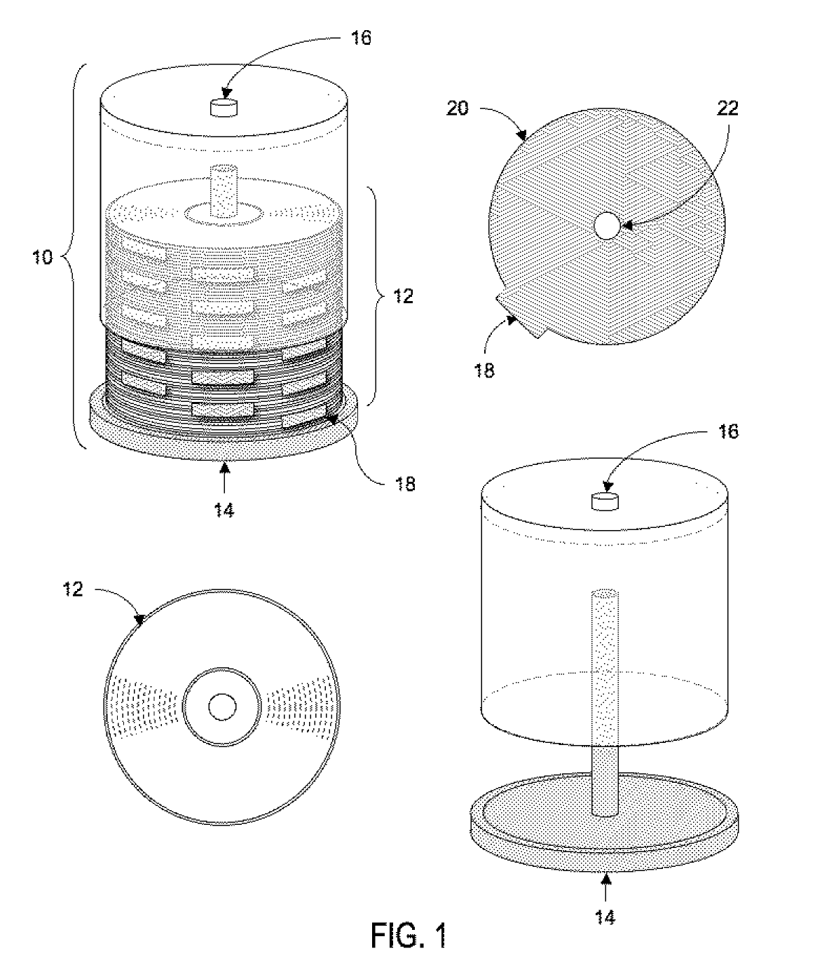

FIG. 1 shows one embodiment of a disc storage system 10 with a stack of CD or DVD discs 12 on a central spool 14 and a removable cover 16. The tabs 18 of index sheets 20 between the CD or DVD discs 12 can easily be seen with the cover 16 either assembled on the spool 14 or removed.

An index sheet 20 has dimensions and a center hole 22 which allow it to be assembled on the spool 14 along with CD or DVD discs 12, and a tab 18 which extends beyond the circumference of the discs 12 such that any information printed or written on the tab 18 is clearly visible to identify the disc adjacent to it.

An index sheet 20 is shown in this example embodiment having a single page of circular shape with a single tab 18; however, index sheets of various shapes, sizes, pages and numbers of tabs may be devised without departing from the spirit and scope of the invention.

An index sheet 20 is made of a thin, flexible and durable material in its preferred embodiment. Paper or a derivative material, vinyl or some other synthetic material may be used. Workers skilled in the art will recognize other suitable materials which may be used without departing from the spirit and scope of the invention.

Bulk CD or DVD discs 12 are typically sold in quantities of 25 or more on a spool 14 with a cover 16 similar to the one in the diagram. The insertion of index sheets 20 between the discs 12 on the spool 14 allows the user to retain the discs 12 in their original protective packaging, yet easily find and select an individual disc.

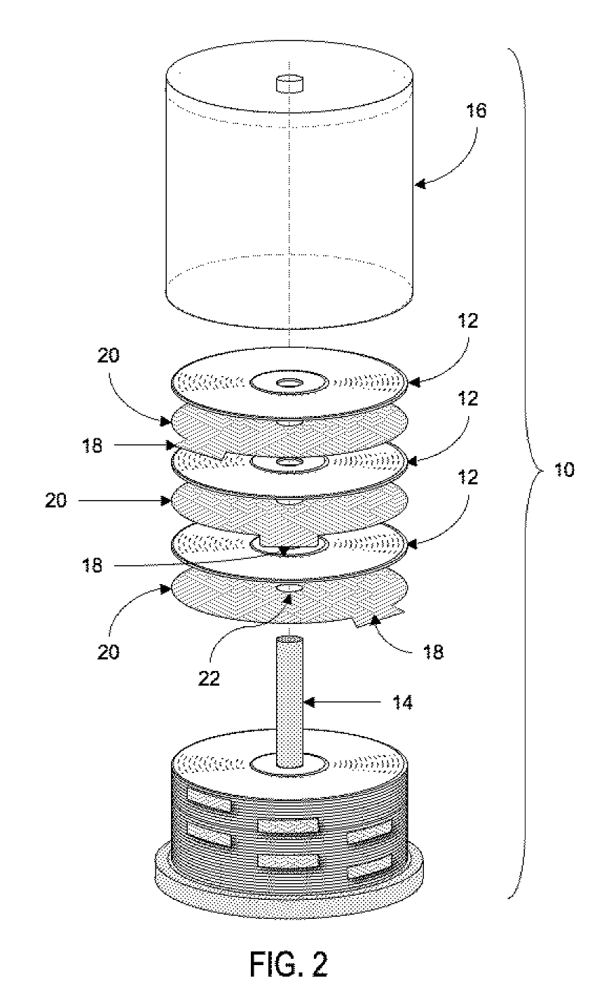

FIG. 2 shows one embodiment of a method for assembling a disc storage system 10. In this example, CD or DVD discs 12 are first removed from the spool 14. Associated index sheets 20 have been prepared with identifying information printed or written on one or both sides of the index sheet 20 and on the tab 18.

The index sheets 20 are then stacked between their associated discs 12 and placed upon the spool 14 which fits within the center hole 22 of the index sheets 20 and discs 12. The cover 16 may then be placed over the stack of discs 12 and index sheets 20 and assembled onto the base of the spool 14. Even with the cover 16 so assembled, the index sheet tabs 18 provide easy identification of their associated discs on the spool.

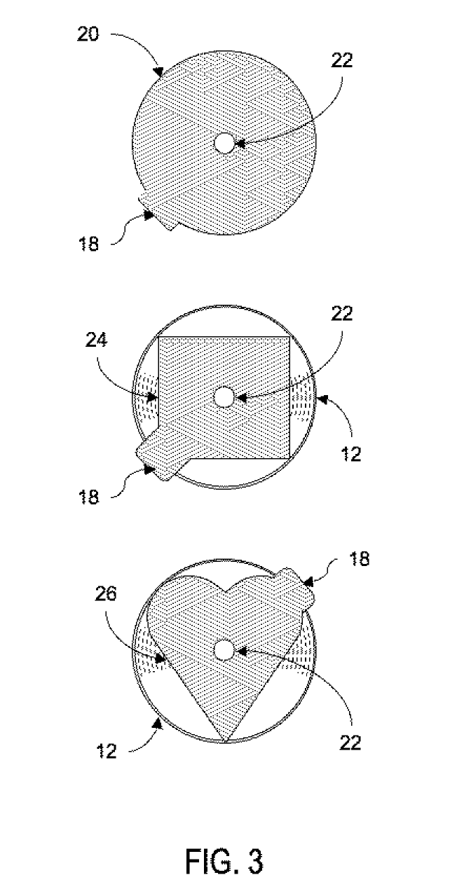

FIG. 3 shows examples of index sheets having different shapes. The circular index sheet 20 is the preferred embodiment of this invention; however, index sheets of square 24, heart-shaped 26, or other shapes could be devised by those skilled in the art without departing from the spirit and scope of the invention.

Note that the square index sheet 24 and the heart-shaped index sheet 26 are each shown in a top view aligned with a CD or DVD disc 12 to clearly show the index sheet dimensions relative to the disc 12, the alignment of the center holes 22 of the index sheets and discs, and the projection of the index sheet tab 18 beyond the circumference of the disc 12.

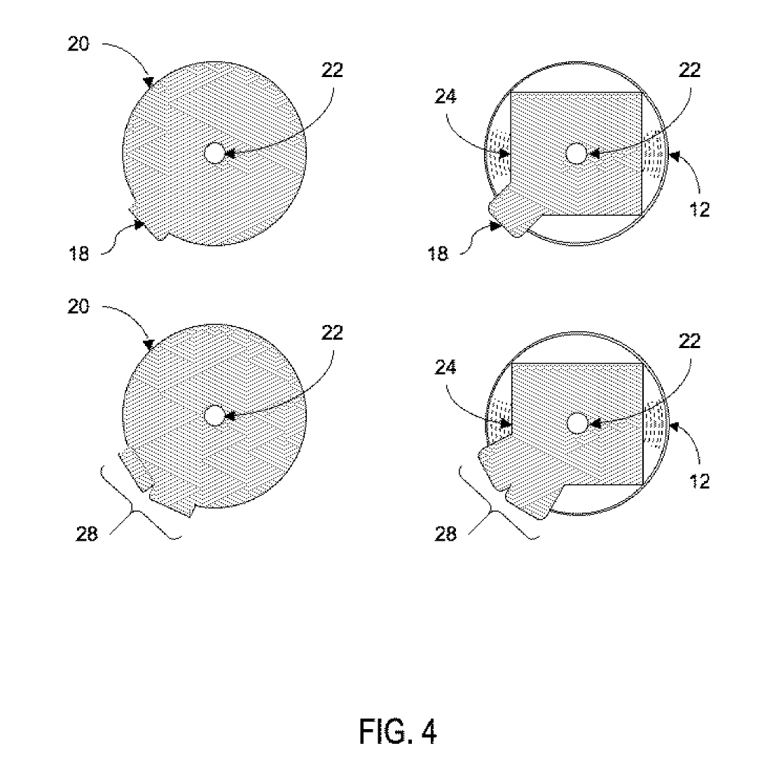

FIG. 4 shows examples of index sheets having one or more tabs. A circular index sheet 20 and a square index sheet 24, each having either a single tab 18 or a double tab 28, are provided as example embodiments. Other numbers of tabs or shapes of index sheets may be devised by those skilled in the art without departing from the spirit and scope of the invention.

Note that the square index sheets 24 are shown in a top view aligned with CD or DVD discs 12 to clearly show the index sheet dimensions relative to the disc 12, the alignment the center holes 22 of the index sheets and discs 12, and the projection of the single tab 18 and of the double tab 28 beyond the circumference of the disc 12.

The dimensions of the double tab 28 on both the circular index sheet 20 and the square index sheet 24 are such that the two tabs align squarely with each other when folded down along the circumference of a CD or DVD disc 12. Such a configuration is common when the index sheets and discs have been stored on a spool 14 and enclosed within a close-fitting cover 16, as shown in the example embodiment of a disc storage system 10 in FIG. 1.

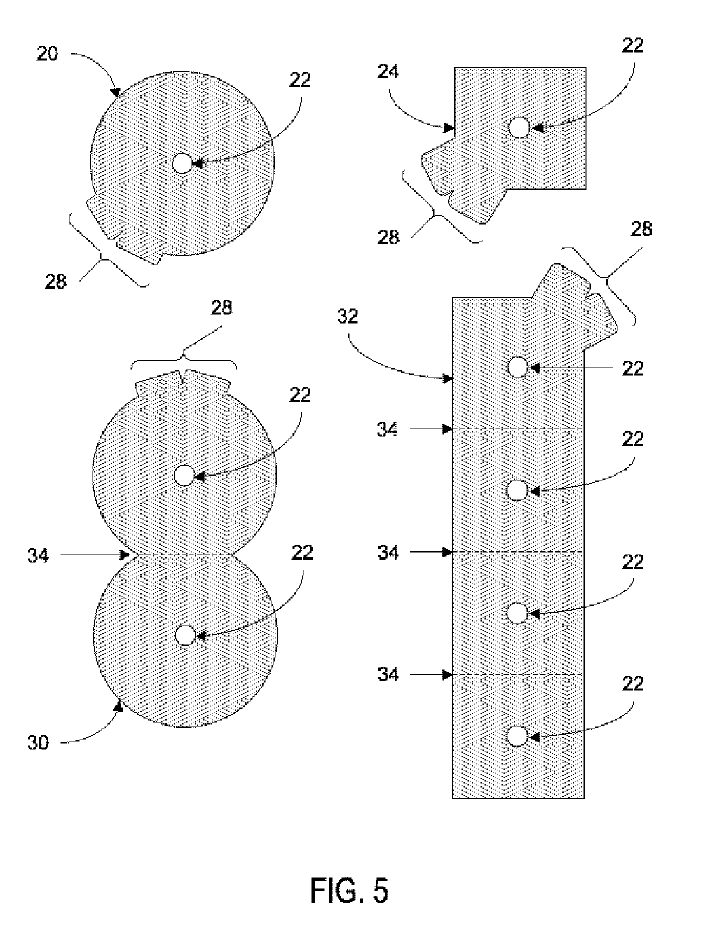

FIG. 5 shows examples of index sheets of various shapes having one or more pages. A circular index sheet having one page 20, a square index sheet having one page 24, a circular index sheet having two pages 30, and a square index sheet having four pages 32 are provided as example embodiments. Other numbers of pages, tabs or shapes of index sheets may be devised by those skilled in the art without departing from the spirit and scope of the invention.

In these example embodiments, the placement of the double tabs 28 and the center hole 22 on each page of the index sheet is clearly shown. The fold line 34 between adjacent sheets is also illustrated, indicating where index sheets having more than one page can be folded in order to be properly assembled with adjacent CD or DVD discs 12 on a spool 14 such that the center holes 22 of the folded index sheets and the discs 12 align properly and the tabs 18 or double tabs 28 provide easy visibility of individual discs assembled together on the spool 14.

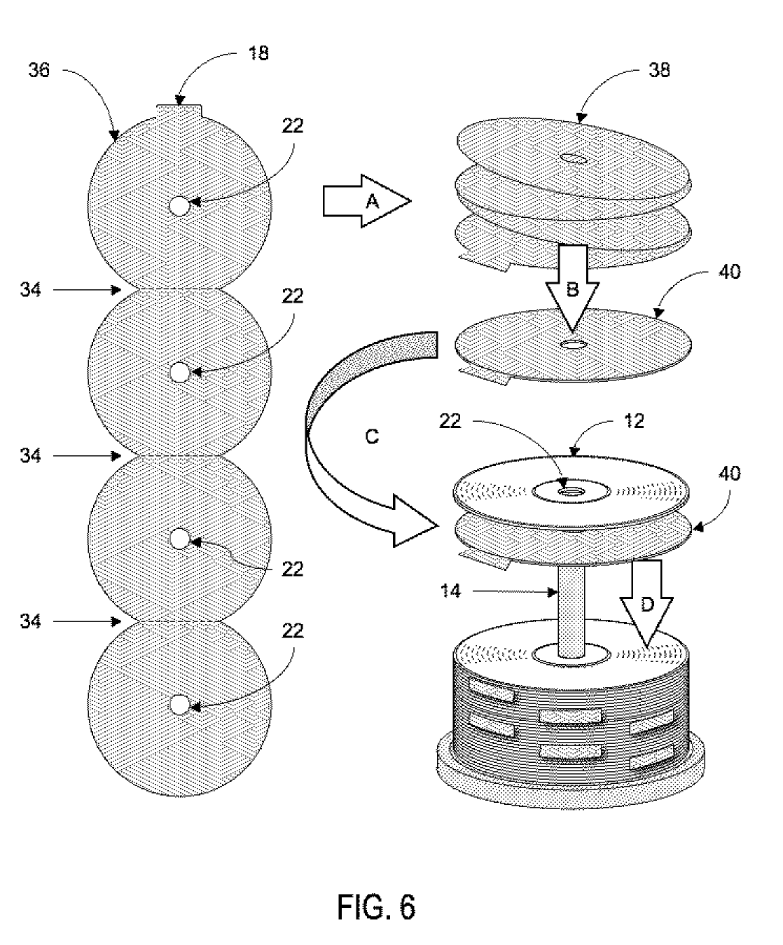

FIG. 6 shows one embodiment of a method for assembling a disc storage system 10 utilizing an index sheets having more than one page. In this example, a four-page circular index sheet 36 with a single tab 18, center holes 22 and fold lines 34 is shown. Of course, index sheets of various shapes and number of pages or tabs may be used without departing from the spirit and scope of the invention.

In step A of this example, the multi-page index sheet 36 is folded along the fold lines 34 to form a booklet 38. In step B, the booklet 38 is then folded flat 40, having dimensions similar to a single-page circular index sheet 20. In step C, the fully-folded index sheet 40 is then stacked adjacent to its associated CD or DVD disc 12. In step D, the fully-folded index sheet 40 and its associated disc 12 are placed upon a spool 14 which fits within the center holes 22 of the fully-folded index sheet 40 and disc 12.

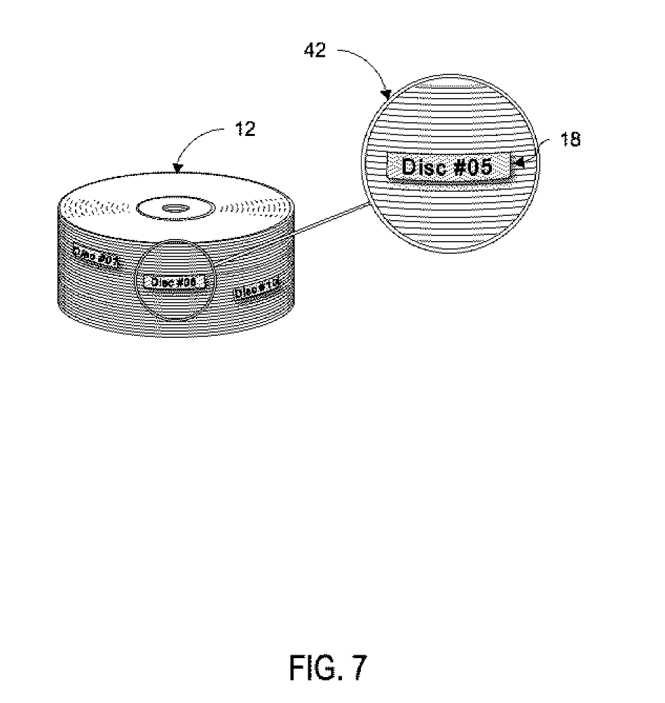

FIG. 7 shows one embodiment of a method for printing or writing information on the tab 18 of an index sheet. In this example, the information “Disc #05” is printed; however, any type of information may be printed.

The information is placed on the tab 18 such that it faces upward and is easily visible as the tab extends beyond the circumference of the stack of CD or DVD discs 12. If the CD or DVD discs 12 are placed on a spool 14 and enclosed within a close-fitting cover 16, the information printed on the tab 18 is still clearly visible, as the tab 18 is folded flat along the circumference of the stack of discs 12 and the information now displays outward, as shown in the enlarged illustration 42.

The information may be written by hand on the tab 18 of the index sheet, or printed on the tab of the index sheet by conventional methods including common inkjet or laser printers.

While an index sheet having a single tab 18 is used in this example, information may similarly be printed on index sheets having two or more tabs without departing from the spirit and scope of the invention.

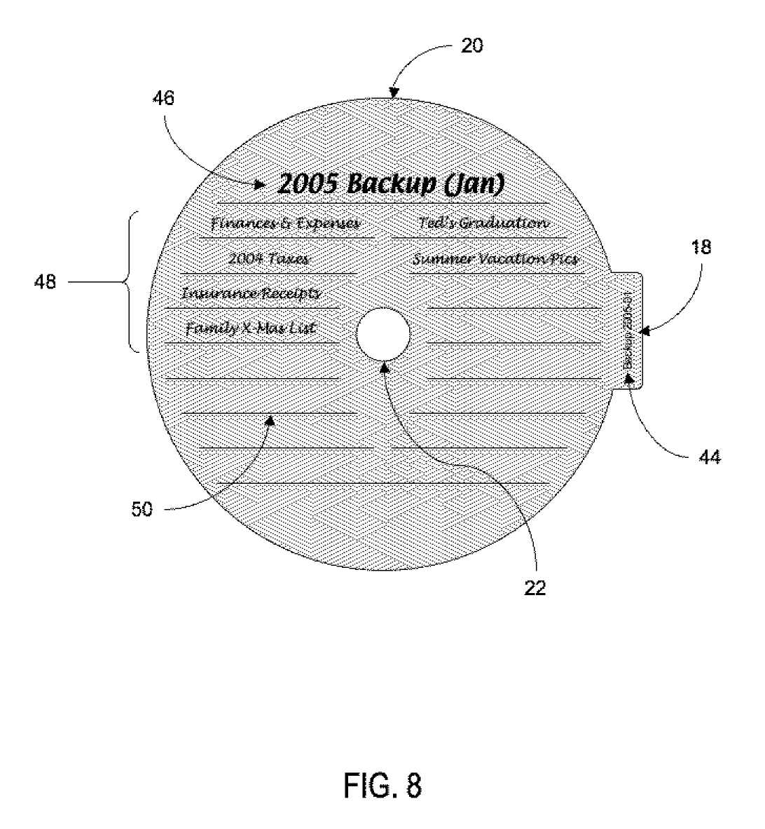

FIG. 8 shows an example embodiment of an index sheet 20 with center hole 22 and tab 18. In this example, the index sheet 20 and tab 18 have information printed or written upon them including a disc title and a listing of selected files or folders stored on a CD or DVD disc. The printed information includes the disc index title 44 printed on the tab 18, the disc full title 46, an example listing of files or folders 48 and graphic lines 50.

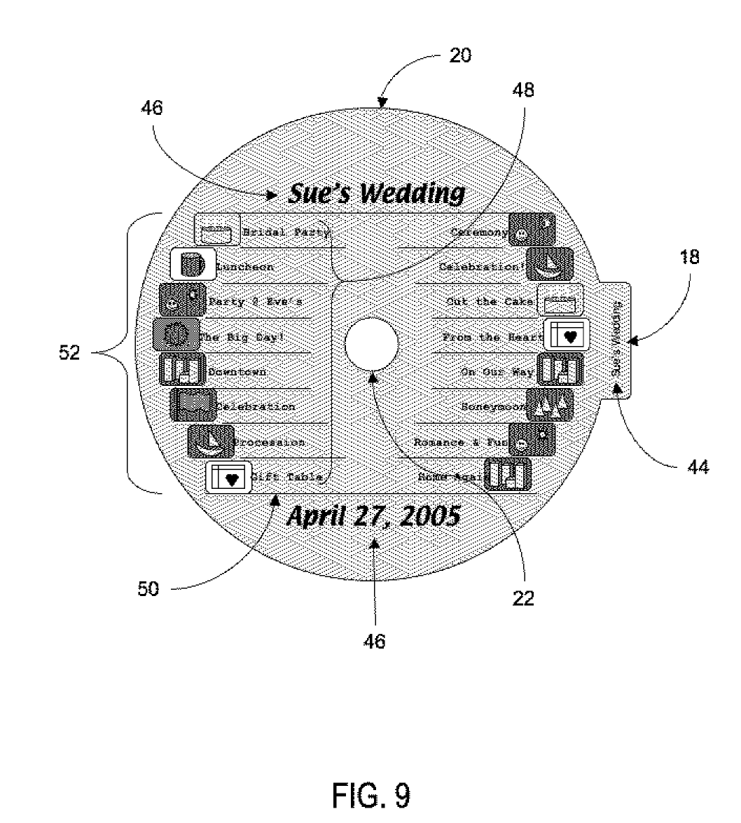

FIG. 9 shows an example embodiment of an index sheet 20 with center hole 22 and tab 18. In this example, the index sheet 20 and tab 18 have information printed or written upon them including a disc title and an array of thumbnail images and associated file or folder names corresponding to selected image files or folders stored on a CD or DVD disc. The printed information includes the disc index title 44 printed on the tab 18, the disc full title 46, an array of sample thumbnail images 52, an example listing of files or folders 48 and graphic lines 50.

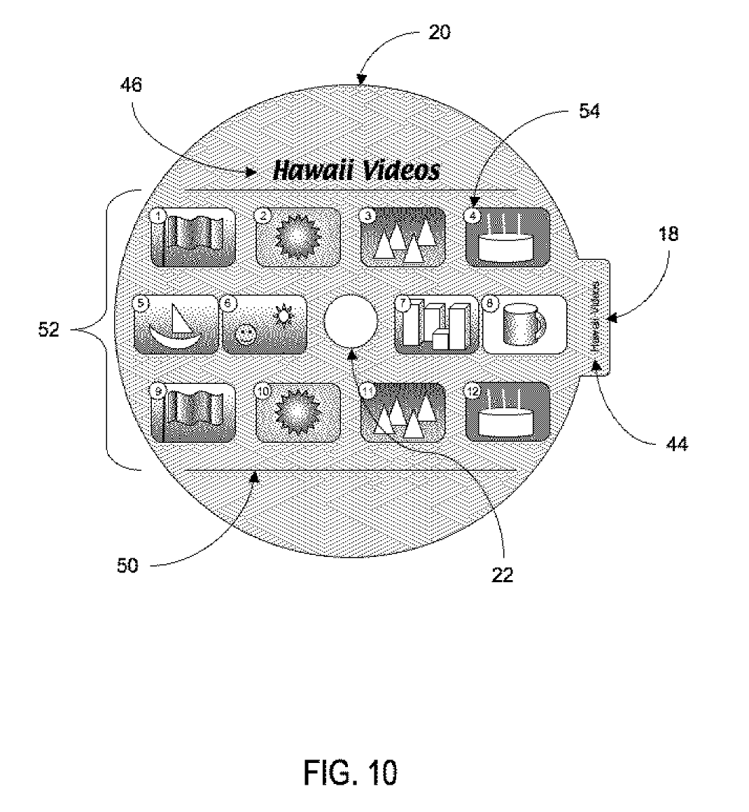

FIG. 10 shows an example embodiment of an index sheet 20 with center hole 22 and tab 18. In this example, the index sheet 20 and tab 18 have information printed or written upon them including a disc title and an array of thumbnail images corresponding to selected video titles or chapters stored on a CD or DVD disc. The printed information includes the disc index title 44 printed on the tab 18, the disc full title 46, an array of sample thumbnail images 52, and graphic lines 50. In the example, each thumbnail image has the associated video chapter number 54 indicated upon it.

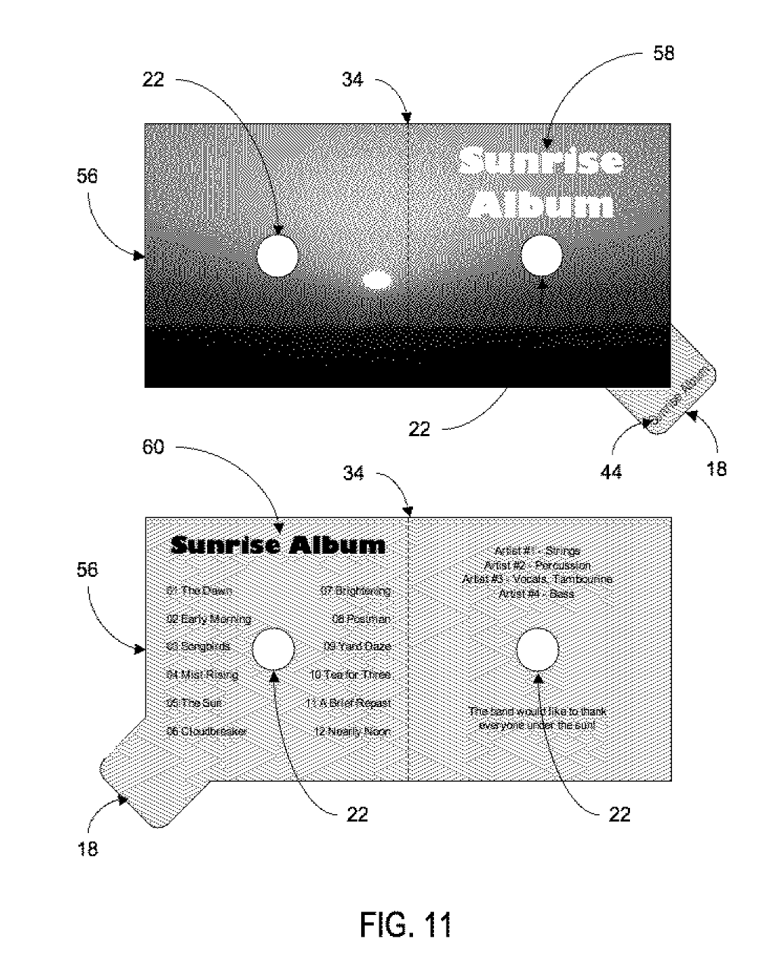

FIG. 11 shows an example embodiment of a two-page square index sheet 56 with center holes 22, fold lines 34 and a single tab 18. In this example, the index sheet 56 has information printed on both sides of each page and the tab 18 has the disc index title 44 printed on one side. On the front side of the index sheet 56, a graphic image is printed representing album art 58. On the back side of the index sheet 56, information representing liner notes 60 is printed.

For each of the example embodiments represented in FIG. 8, FIG. 9, FIG. 10 and FIG. 11, the information may be written by hand on the index sheet 20 and tab 18, or printed on the index sheet 20 and tab 18 by conventional methods including common inkjet or laser printers. Many variations on the format and content of printed information may be devised by those skilled in the art without departing from the spirit and scope of the invention.

Thus, the present invention is an improvement in the art in that it provides for making an index sheet with an identifying tab which can be assembled along with CD or DVD discs on the original spool. Additional storage devices are not required, the discs are easily identified and selected for use, and additional information may be printed on the index sheet related to the contents of the disc.

Although the present invention has been described with reference to many preferred and example embodiments, those skilled in the art will recognize that changes in form and detail may be made without departing from the spirit and scope of the invention.

1. A disc storage system comprising: CD or DVD discs assembled on a spool; index sheets assembled on the spool between the discs such that the index sheet tabs provide easy identification and selection of individual discs on the spool; an optional removable cover to protect the discs on the spool while still providing visibility to the index sheet tabs.

2. A method for assembling index sheets and CD or DVD discs on a spool such that the index sheet tabs provide easy identification and selection of individual discs on the spool.

3. An index sheet comprising: a tabbed sheet of one or more pages with dimensions and a center hole allowing it to be placed on or between CD or DVD discs stored on a spool such that the tab or tabs extend beyond the circumference of the discs and may be easily seen.

4. The index sheet of claim 3 wherein the index sheet has a single page.

5. The index sheet of claim 3 wherein the index sheet has two or more pages which can be folded together to form a booklet.

6. The index sheet of claim 3 wherein the index sheet has a single tab.

7. The index sheet of claim 3 wherein the index sheet has two or more tabs which have dimensions allowing them to align squarely along the circumference of a spool of CD or DVD discs.

8. The index sheet of claim 3 wherein the index sheet has one or more pages of a circular shape, each page having a center hole and dimensions allowing it to be placed on or between CD or DVD discs stored on a spool.

9. The index sheet of claim 3 wherein the index sheet has one or more pages of a square or rectangular shape, each page having a center hole and dimensions allowing it to be placed on or between CD or DVD discs stored on a spool.

10. The index sheet of claim 3 wherein the index sheet has one or more pages of any other shape (for example, heart-shaped, octagonal or other more novel shapes), each page having a center hole and dimensions allowing it to be placed on or between CD or DVD discs stored on a spool.

11. A method for printing or writing a CD or DVD title or other information on the tab or tabs of an index sheet.

12. A method for printing or writing information, graphics or images on one or both sides of an index sheet having one or more pages.

13. The method of claim 12 wherein the printed information includes a listing of selected files and folders stored on a CD or DVD.

14. The method of claim 12 wherein the printed information includes a listing of selected image files and folders stored on a CD or DVD and an array of thumbnail images corresponding to the selected image files and folders stored on a CD or DVD.

15. The method of claim 12 wherein the printed information includes a listing of selected video titles or chapters stored on a CD or DVD and an array of thumbnail images corresponding to the selected video titles or chapters stored on a CD or DVD.

16. The method of claim 12 wherein the printed information includes graphics, pictures, single video frames, album art, liner notes or other images.
